(19) United States
(12) Patent Application Publication
(10) Pub. No.: US 2004/0172936 A1
(43) Pub. Date: Sep. 9, 2004

(54) Torque converter

(75) Inventors: Bruno Mueller, Buehl (DE); Philip George, Wooster (DE); Christine Buedenbender, Buehl (DE); Todd Sturgin, Wooster, OH (US); Yongfu Liu, Wooster, OH (US); Aliihsan Karamavruc, Wooster, OH (US); Adam Uhler, Sterling, OH (US); Ramakant Rambhatla, Wooster, OH (US); Steven Olsen, Wooster, OH (US); Mike Clason, Wooster, OH (US); Joachim Hoffmann, Wooster, OH (US); Scott Schrader, Canton, OH (US)

Correspondence Address: DAVIDSON, DAVIDSON & KAPPEL, LLC, 485 SEVENTH AVENUE, 14TH FLOOR, NEW YORK, NY, 10018, US

(73) Assignee: LUK LAMELLEN UND KUPPLUNGSBAU BETEILIGUNGS KG, Buehl (DE)

(21) Appl. No.: 10/794,982

(22) Filed: Mar. 5, 2004

(30) Foreign Application Priority Data
Mar. 5, 2003 (DE) DE 103 09 830.5

(51) Int. Cl. F16D 33/00

(52) U.S. Cl. 60/330

(57) ABSTRACT

A method and a device are described for influencing the flow in a torque converter. The peripheral velocity of the fluid on its way to the open end of the transmission input shaft is made to approach the respective peripheral velocity of the converter housing.

This claims the benefit of German Patent Application No. 103 09 830.5, filed Mar. 5, 2003 and hereby incorporated by reference herein.

### BACKGROUND INFORMATION

The present invention relates to a torque converter.

It is known from the related art that the fluid —preferably oil—filling the torque converter is continuously replaced. The fluid is pumped into the space containing the pump, turbine (rotor), and stator. The fluid then exits through the radially outer gap between the pump and the turbine. Subsequently this fluid enters the space between the outside of the turbine (the side facing away from the turbine vanes) and the crankshaft-side internal surface of the converter housing. The fluid is then removed again via the transmission input shaft engaging with the torque converter. The fluid may be removed via a concentric bore hole or another channel.

Due to the high rotational speed of the torque converter and the associated high centrifugal forces, a high fluid pumping pressure is required to bring the fluid into the proximity of the return bore hole. A high fluid pumping pressure requires a high power consumption just to replace the fluid. This is disadvantageous because without a high pressure the accumulating fluid does not flow back quickly enough.

If the torque converter in question has only one fluid inlet and one fluid outlet (dual channel system), the converter bypass clutch (if present in the torque converter in question) is also actuated by the returning fluid.

In three-channel systems there is a separate hydrostatic channel for actuating the converter bypass clutch. Yet the problem of returning fluid build-up still remains.

In dual channel systems, the accumulating fluid usually has a negative effect on the rapid response of the converter bypass clutch, because the fluid also accumulates in the space between the piston of the converter bypass clutch and the crankshaft-side internal surface of the converter. This is particularly disadvantageous when the converter bypass clutch must also be operated in the slipping mode.

### BRIEF SUMMARY OF THE INVENTION

An object of the present invention is to provide a method and a torque converter which at least reduce the above-named disadvantages.

The present invention provides a method for influencing the flow in a torque converter. In the area between the turbine and the crankshaft-side internal face of the housing and, at the same time in the area near the axis of rotation of the torque converter, there is at least one means which causes the radius-specific rotation flow velocity of the fluid to approach the radius-specific peripheral velocity of the converter housing.

The present invention also provides a torque converter wherein in the area between the outer surface of the turbine and the inner surface of the torque converter housing at least one hydraulic unevenness is situated, which represents a deflector or a guide element, which has at least one surface extending radially and axially at the same time.

The inventors have recognized that, when the fluid exits from the gap between the pump and the turbine, the fluid initially rotates with the peripheral velocity of the largest internal diameter of the converter. The inventors have further recognized that the fluid essentially preserves this velocity vector due to the return flow of the fluid toward the axis of rotation of the torque converter. A slight reduction in this vector results from the friction of the fluid strata gliding against one another. The further the returning fluid wanders radially inward—at an essentially constant peripheral fluid velocity—the faster the corresponding fluid stratum rotates. As recognized by the inventors, this results in higher and higher angular velocities directed radially inward for a simultaneously decreasing effective radius. The resulting increase in the centrifugal forces makes it increasingly more difficult to move the returning fluid toward the transmission input shaft.

Therefore, according to the present invention, the peripheral fluid velocity is reduced by at least one hydraulic unevenness, represented for example by a deflector or a guide element, in the radially internal area of the torque converter. In the best case, the peripheral velocity of the fluid then becomes equal to the radius-specific peripheral velocity of the respective torque converter component carrying the guide element. In practice, the radius-specific peripheral velocity of the fluid will only approach the radius-specific peripheral velocity of the torque converter component. The velocity of the fluid is reduced due to the formation of turbulence and/or increase in the frictional losses, among other things.

### BRIEF DESCRIPTION OF THE DRAWINGS

Further advantageous embodiments of the present invention are described in the subclaims and elucidated with reference to the drawing, where

FIG. 1 shows a cross-section through a torque converter having a guide element on the crankshaft side;

FIG. 2 shows a cross-section through a torque converter having a guide element on the hub side;

FIG. 3 shows a cross-section through a torque converter having a guide element on the hub side;

FIG. 4A shows an A-A section view of FIG. 4B, which is a plan view of a guide element having spiral-shaped grooves;

FIGS. 5A shows a B-B section view of FIG. 5B, which is a plan view of a guide element having radial grooves;

FIG. 6 shows a partial cross-section through a torque converter having a stopping disk having spiral grooves;

FIG. 7 shows a view A of FIG. 6;

FIGS. 8 and 9 show perspective views of a guide element made of stamped sheet metal;

FIG. 10 shows a partial cross-section through a torque converter having a riveted disk having external teeth and a guide element on the hub side;

FIGS. 11 and 12 show perspective views of the guide element of FIG. 10;

FIGS. 13 and 14 show a section view and a plan view of the disk having external teeth.

### DETAILED DESCRIPTION

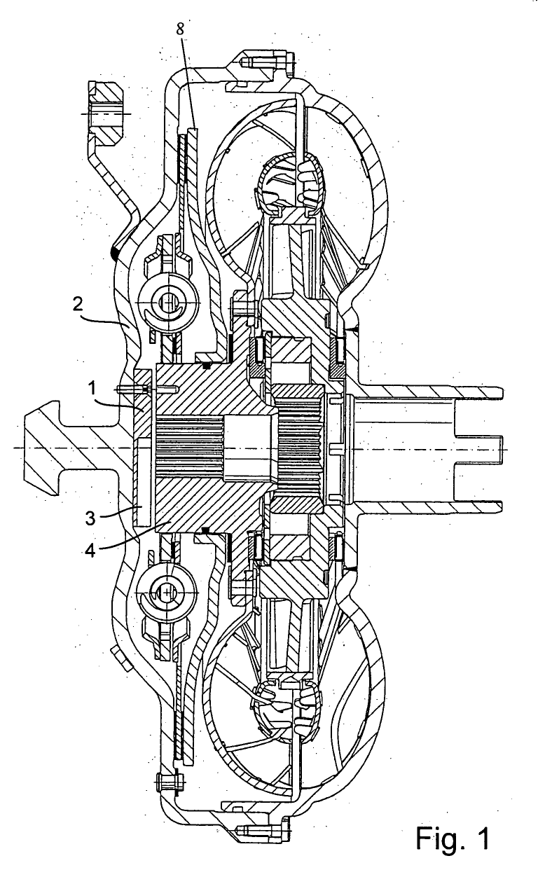

In FIG. 1, a guide element 1 is screwed onto the crankshaft-side internal surface of torque converter 2 having a converter bypass clutch with a piston 8. U.S. Pat. Nos. 6,325,191 and 6,615,962 are hereby incorporated by reference herein and disclose hydraulic torque converters with bypass clutches.

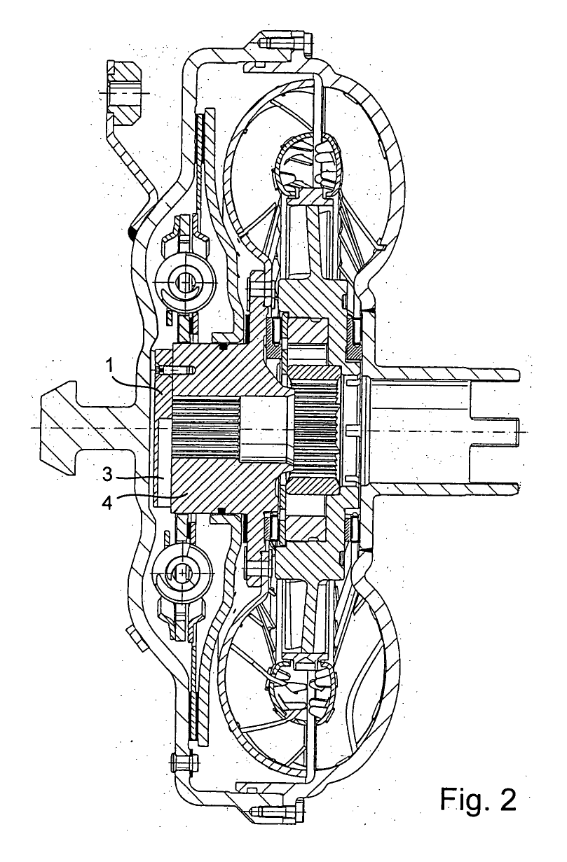

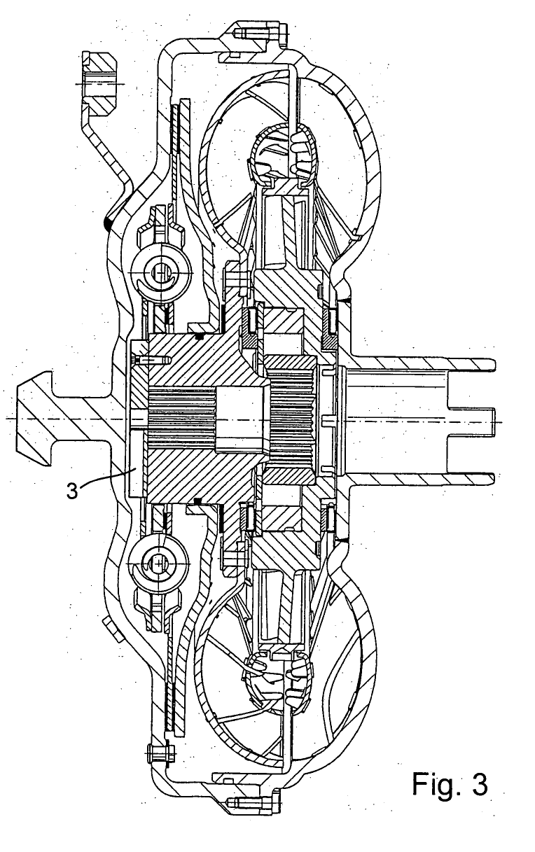

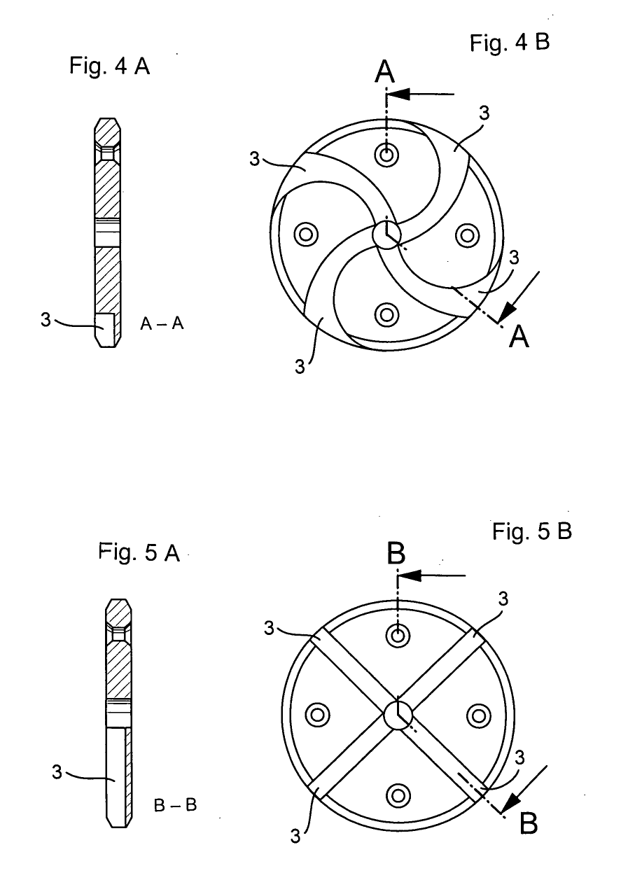

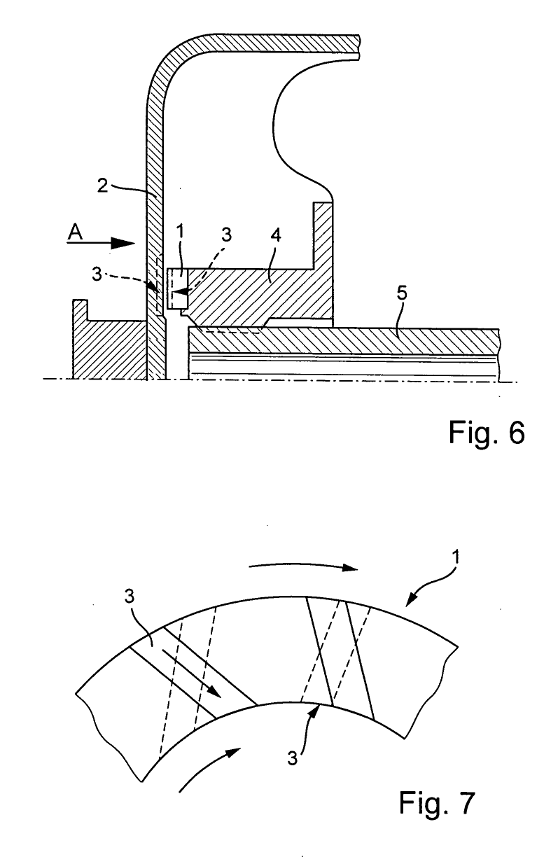

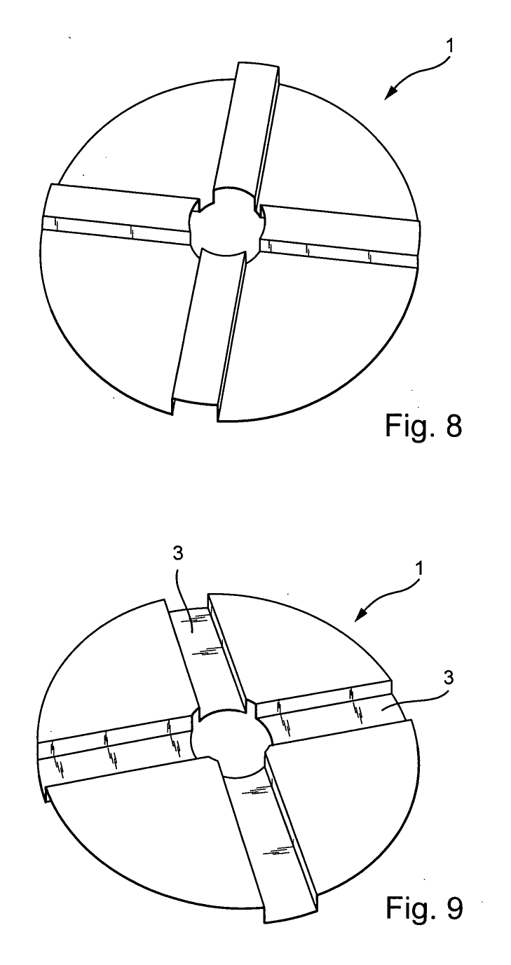

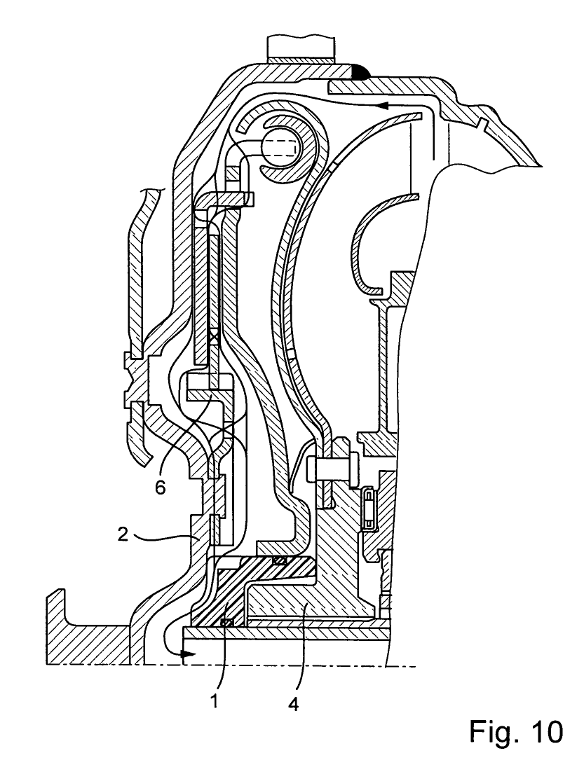

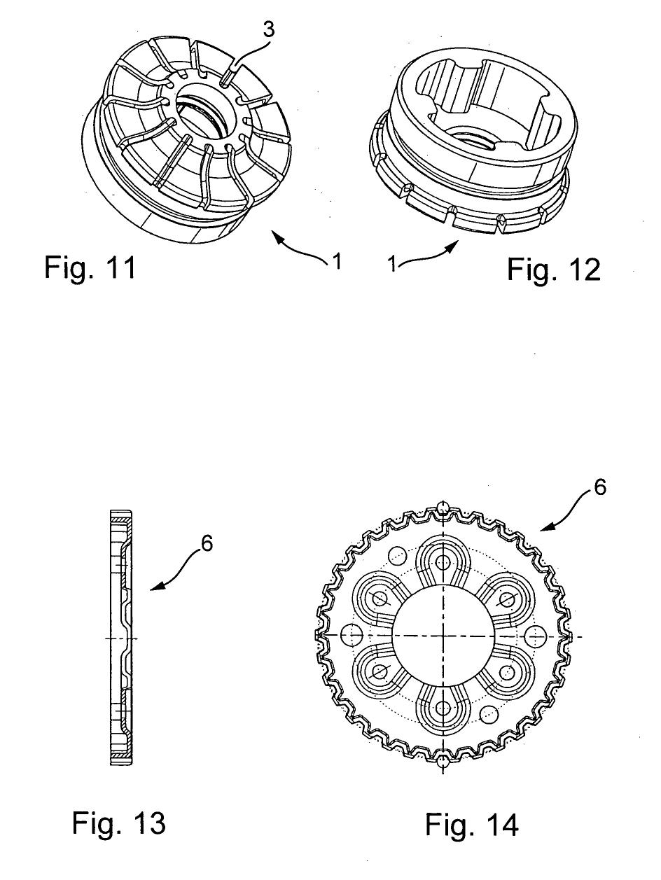

A groove 3 extends radially in the guide element designed as a solid body. In contrast to FIG. 1, in FIG. 2 guide element 1 is mounted on a hub 4. In FIG. 3, the guide element is also screwed onto hub 4, but the open side of groove 3 faces the crankshaft-side internal surface of the converter. In the example of FIG. 3 a central bore hole is present to permit the fluid to enter the open end of the transmission input shaft. In FIGS. 1 through 3, guide element 1 is used not as a stopping surface, i.e., as an axial bearing, because the gap between guide element 1 and the adjacent components are clearly visible here. FIGS. 4A, 4B, 5A and 5B show embodiments for guide elements 1 of FIGS. 1 through 3. Sections A-A and B-B illustrate the particular shape of grooves 3. Guide elements 1 may be provided on the adjacent component using optionally either of their planar surfaces due to the countersinking on both sides of the attachment holes. Spiral-shaped and oblique-radial guide elements 1 in the form of grooves are provided in both converter housing 2 and in the stopping disk in FIGS. 6 and 7, respectively. Due to the relative motion between housing 2 and stopping disk (see FIG. 7, view A of FIG. 6), oil is additionally pumped radially inward. FIGS. 8 and 9 show a guide element 1 made of sheet metal having grooves 3 stamped crosswise. Because this guide element 1 is made of sheet metal, it may be advantageously riveted. A rivet button joint is particularly advantageous because it prevents leaks in the converter housing (the holes for the riveted joint are omitted in the drawing). In the torque converter of FIG. 10, a disk 6 having outer teeth is riveted to the converter housing 2 using button rivets. A guide element 1 having radial grooves inclined in the axial direction is associated with hub 4. The arrowed lines show different stretches of the possible oil flow. Guide element 1 of FIG. 10 may be as shown in FIGS. 11 and 12. A disk 6 of FIG. 10 is also well-suited to reduce a relatively higher fluid peripheral fluid velocity due to its structured surface. The torque converter illustrated is, however, also noteworthy in that the flux of force in the central part of the turbine damper (here three friction boundary surfaces=three partial fluid streams) is bound to converter housing 2.

The guide element may be integral with one of the converter parts, or a separate part thereto.

What is claimed is:

1. A method for influencing the flow of fluid in a torque converter having a turbine, a housing having a crankshaft-side internal face, and an axis of rotation, the method comprising:
causing a radius-specific rotational flow velocity of the fluid to approach a radius-specific peripheral velocity of the converter housing in the area between the turbine and the crankshaft-side internal face of the housing and at the same time in the area about the axis of rotation of the torque converter.

2. The method preferably as recited in claim 1 wherein the flow velocity is reduced by formation of turbulence and/or friction of the fluid.

3. The method preferably as recited in claim 1 wherein the causing step is achieved by providing a shaped structure to skim off and forward the fluid into an internal diameter area of the torque converter and thus to the open end of a transmission input shaft.

4. The method preferably as recited in claim 3 wherein in a torque converter having a converter bypass clutch the fluid velocity is reduced in the area between a piston of the converter bypass clutch and the internal face of the housing.

5. A torque converter for a vehicle comprising:
a turbine having an outer surface; and
a housing having an inner surface; and
a deflector or guide element in the area between the outer surface of the turbine and the inner surface of the torque converter housing providing at least one hydraulic unevenness, the deflector or guide element having at least one surface extending radially and axially at the same time.

6. The torque converter as recited in claim 5 wherein the guide element is embedded in the inner surface of the housing.

7. The torque converter as recited in claim 5 wherein the guide element is an additional component to the turbine or housing.

8. The torque converter as recited in claim 5 wherein the guide element is provided in the inner surface of the housing.

9. The torque converter as recited in claim 5 wherein the guide element is provided on a hub of the turbine or on a transmission input shaft.

10. The torque converter as recited in claim 7 wherein the guide element is riveted to the inner surface of the housing.

11. The torque converter as recited in claim 9 wherein the guide element is attached to the inner surface of the housing by button riveting.

12. The torque converter as recited in claim 5 wherein the guide element is attached to the internal surface of the housing by spot welding.

13. The torque converter as recited in claim 5 wherein the guide element is screwed onto the turbine hub or the internal surface of the housing.

14. The torque converter as recited in claim 5 wherein the guide element is made of pressed sheet metal.

15. The torque converter as recited in claim 5 wherein the guide element is made of a solid body.

16. The torque converter as recited in claim 5 wherein the guide element has a spiral surface.

17. The torque converter as recited in claim 5 wherein a disk having external teeth, engaged by a clutch disk having internal teeth is connected to the crankshaft-side wall of the converter housing.

18. The torque converter as recited in claim 17 wherein the toothed disk is attached to the wall by rivets.

19. The torque converter as recited in claim 18 wherein the rivets are button rivets.

20. The torque converter as recited in claim 5 wherein the torque converter is a motor vehicle torque converter.
